(19) United States
(12) Patent Application Publication
(10) Pub. No.: US 2006/0196331 A1
(43) Pub. Date: Sep. 7, 2006

(54) Kiss cut die and method

(75) Inventor: Ralph McGuigan, Phoenix, AZ (US)

Correspondence Address: Paul F. Wille;Cantor Colburn LLP, 55 Griffin Road South, Bloomfield, CT, 06002, US

(73) Assignee: World Properties, Inc., Lincolnwood, IL (US)

(21) Appl. No.: 11/069,262

(22) Filed: Mar. 1, 2005

(51) Int. Cl. B26F 1/14

(52) U.S. Cl. 83/55; 83/686; 83/143

(57) ABSTRACT

In a punch and die set, the punch includes an inner section and an outer section, wherein the inner section is higher than the outer section, a cutting die for receiving the punch, and a stripper die movable within the cutting die. Because the inner section is higher than the outer section, the stripper die engages a workpiece first as the punch enters the cutting die, producing a kiss cut. The punch can further enter the die to provide a blanking cut. A pressure pad within the stripper die holds a workpiece in place for cutting.

### CROSS-REFERENCE TO RELATED APPLICATION

This application relates to application Ser. No. 10/790,978, filed Mar. 2, 2004, entitled Dimensionally Stable Electroluminescent Lamp without Substrate, and assigned to the assignee of this invention. The entire contents of said application are incorporated by reference into this application.

### BACKGROUND OF THE INVENTION

This invention relates to the manufacture of flexible, laminated sheet materials and has a particular application in the manufacturer of electroluminescent (EL) panels for separating lamps from a release layer.

As used herein, and as understood by those of skill in the art, “thick-film” refers to one type of EL lamp and “thin-film” refers to another type of EL lamp. A thin, thick-film EL lamp is not a contradiction in terms and such a lamp is considerably thicker than a thin film EL lamp.

As used herein, an EL “panel” is a single sheet including one or more luminous areas, wherein each luminous area is an EL “lamp.” An EL lamp is essentially a capacitor having a dielectric layer between two conductive electrodes, one of which is transparent. The dielectric layer can include phosphor particles or there can be a separate layer of phosphor particles adjacent the dielectric layer. The phosphor particles radiate light in the presence of a strong electric field, using relatively little current.

A modern (post-1985) EL lamp typically includes transparent substrate of polyester or polycarbonate material having a thickness of about 7.0 mils (0.178 mm.). A transparent, front electrode of indium tin oxide or indium oxide is vacuum deposited onto the substrate to a thickness of 1000 Å or so. A phosphor layer is screen printed over the front electrode and a dielectric layer is screen printed over phosphor layer. A rear electrode is screen printed over the dielectric layer. It is also known in the art to deposit the layers by roll coating.

An EL lamp constructed in accordance with the prior art is relatively stiff, even though it is typically only seven mils thick, making the lamp unsuited to some applications requiring greater flexibility, such as keypads. Layer thickness and stiffness are not directly related. The material from which the layer is made affects stiffness. Simply reducing the thickness of the substrate does not provide the desired flexibility.

The above-identified application discloses a relatively flexible EL panel made on a UV-cured urethane layer on a release layer. The release layer provides substantial structural support while the lamp layers are applied. Panels made as described in the above-identified application have structural integrity but are somewhat delicate. Removing a panel from the release layer is postponed as long as possible.

One technique that aids postponement is that the lamp is kiss cut while on the release layer. A kiss-cut is a cut through some but not all of the layers in an article, without cutting the substrate on which the layers were deposited. As applied to the manufacture of EL lamps, the lamp materials are cut but remain on the release layer, which is intact. The panels can then be manipulated as desired and separated just prior to applying a panel to a keyboard or keypad, for example.

A convenient method for kiss cutting a group of panels is an etched die, illustrated in FIG. 1, having raised outlines of the panels formed on a sheet of stainless steel. Sheets of panels and the die are suitably positioned in a press and the press is actuated to kiss cut the panels. A problem with this approach is the number of panels obtainable from a die. An etched die is typically useful for 50,000 or so stampings, which may seem like a lot until one realizes that the need is one or two orders of magnitude greater, per month, and that, when one outline goes bad, the whole die-is useless.

A continuous supply of die must be kept in inventory and the die are not inexpensive. Neither is the press for the die. Also, the figure given for die life is an average.. Some die last only five or six thousand stampings while other last up to one hundred thousand stampings. Thus, inventory must include several die to be sure to be able to finish just one day's production. Inventory control is made more difficult by the fact that an etched die is a specialized tool, purchased from an outside source. The die cannot be maintained internally. In fact, it is not maintained at all. It is returned to the manufacturer. It is much preferred to build or at least maintain tooling internally, thereby eliminating delivery problems and reducing costs still further.

With a simple punch and die set, the punch pushes a cutting into the die. In order to remove the cutting, it is known in the art to use a stripper die, within the die, to push out the cutting prior to the next punching operation. In the prior art, a stripper die was unnecessary for a kiss cut because there was no separate cutting.

In view of the foregoing, it is therefore an object of the invention to provide a long-life die for kiss cutting a laminated sheet.

Another object of the invention to provide a die for kiss cutting and blanking an article from a laminated sheet.

A further object of the invention is to provide a method for kiss cutting and blanking an article from a laminated sheet.

Another object of the invention is to provide an improved die for blanking flexible EL lamps.

A further object of the invention is to provide an improved kiss cut die that is more easily maintained than an etched die.

Another object of the invention is to reduce the cost of cutting articles from a laminated strip.

### SUMMARY OF THE INVENTION

The foregoing objects are achieved by this invention by a punch and die set in which the punch includes an inner section and an outer section, wherein the inner section is higher than the outer section, a cutting die for receiving the punch, and a stripper die movable within the cutting die. Because the inner section is higher than the outer section, the stripper die engages a workpiece first as the punch enters the die, producing a kiss cut. The punch can further enter the die to provide a blanking cut. A pressure pad within the stripper die holds a workpiece in place for cutting.

### BRIEF DESCRIPTION OF THE DRAWINGS

A more complete understanding of the invention can be obtained by considering the following detailed description in conjunction with the accompanying drawings, in which:

FIG. 1 is a plan view of a etch die constructed in accordance with the prior art;

FIG. 2 is a cross-section of a thin, thick film, flexible EL lamp;

FIG. 3 is a plan view of a release layer containing graphics for referencing the orientation of a panel;

FIG. 4 is a plan view of a finished lamp panel;

FIG. 5 is a cross-sectional view of a press constructed in accordance with a preferred embodiment of the invention; and

FIG. 6 is a top view of a portion of the system illustrated in FIG. 5.

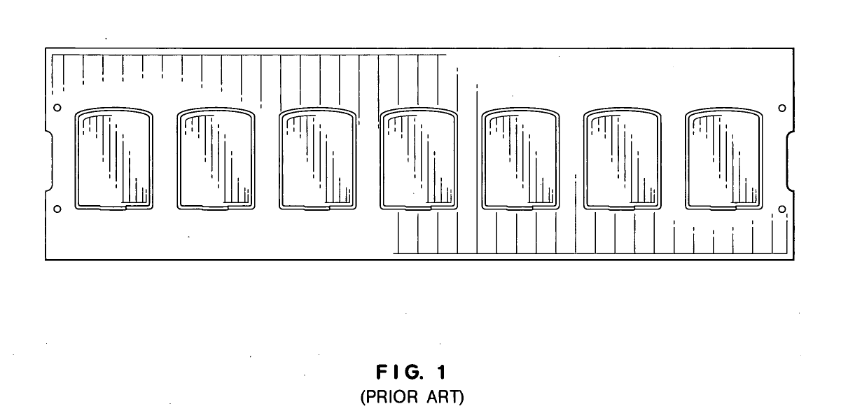

### DETAILED DESCRIPTION OF THE INVENTION

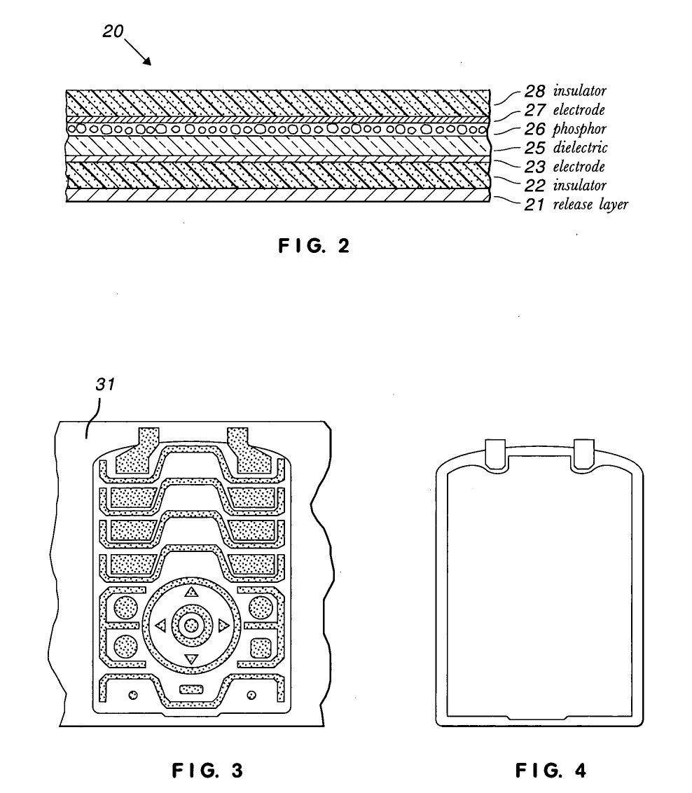

FIG. 2 is a cross-section of an EL lamp constructed as described in the above-identified application. Lamp 20 includes release layer 21 with insulating layer 22 deposited thereon, e.g. by screen printing or other technique known in the art. The release layer is a coated paper or a plastic sheet, such as polyethylene terephthalate (PET), supplied in rolls, which facilitates handling the lamps and integrating the lamps into appliances or molding apparatus. None of the layers is drawn to scale. Layer 21, for example, is about 1-5 mil. (0.025-0.127 mm) thick. The phosphor layer and the dielectric layer are each about 1 mil thick.

Electrode 23 is carbon/PEDOT/PSS (Poly-3,4-ethylenedioxythiophene/polystyrenesulfonic acid) (Orgacon™ EL-P 4010; Agfa-Gevaert N.V.) , a conductive polymer composite thatis screen printed on layer 22. Dielectric layer 25 overlies electrode 23 and phosphor layer 26 overlies the dielectric layer. Electrode 27 is made by screen printing a transparent PEDOT/PSS ink (Orgacon™ EL-P 3040; Agfa-Gevaert, N.V.) on phosphor layer 26. Electrode layers 23 and 27 can be patterned to define lit areas of the lamp in a graphic design. Insulating layer 28 overlies electrode 27.

Other layers could be added to the embodiment shown in FIG. 2, such as graphic overlays and protective layers. Any lamp layer can be split to form a plurality of lamps in a single panel.

FIG. 3 illustrates section 31 of a strip or roll containing graphics for orienting a user to the location of lamps in a panel formed on the strip. The strip corresponds to release layer 21 in FIG. 2. FIG. 4 illustrates a panel as it might appear on section 31. Because a protective layer is typically used, the panel is featureless, which is why the graphics are used on the substrate. Given a roll or strip containing a plurality of sections like section 31, the problems is how to separate the panel from the release layer and separate the panels from the strip.

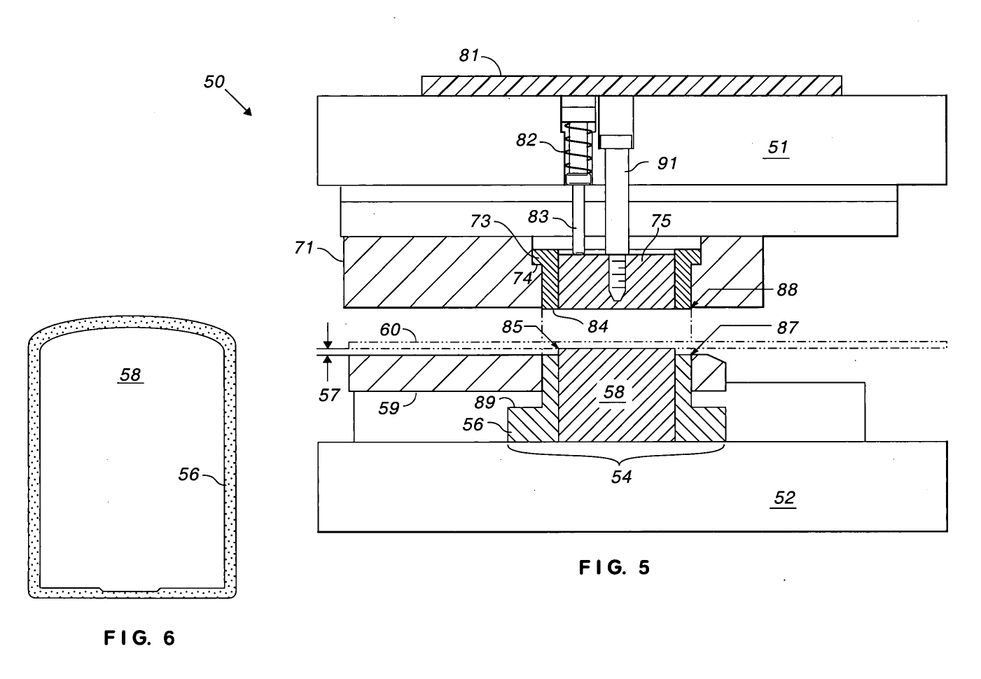

FIG. 5 is a cross-section of a press constructed in accordance with a preferred embodiment of the invention. Press 50 includes a first die attached to movable platen 51 and a punch is attached to fixed platen 52. Obviously, motion is relative and either or both platens can be movable.

Punch 54 includes outer section 56 and inner section 58. While illustrated as separate pieces, a single piece having a raised central section could be used instead. FIG. 6 is a top view of punch 54, showing the outline of an EL panel more clearly. The stippled area corresponds to the upper surface of outer section 56. The white area represents the upper surface of inner section 58. In FIG. 5, inner section 58 extends above the top surface of outer section 56 by height 57, indicated by arrows. In one embodiment of the invention, the height 57 was 7 mils (0.178 mm.) or slightly more than the thickness of a panel. The amount for any given application depends upon the properties of the material.being kiss cut and is readily determined experimentally. Punch 54 is located by guide 59, which can move downward toward platen 52 during operation.

Die 71 is attached to upper platen 51 by suitable means (not shown). Also omitted for clarity from FIG. 5 are stop blocks, guide pins, index pins, actuators, and other details well known to those of ordinary skill in the art of tool making. Die 71 includes a cylindrical opening in which stripper die 73 is located. Shoulder 74 within die 71 engages a corresponding shoulder on the outside of stripper die 73 to limit the downward travel of the stripper die. The cross-sectional (in a plane perpendicular to the plane of the drawing) shape of stripper die 73 is the same as that of outer section 56. Stripper die 73 is tubular or cylindrical and contains pressure pad 75, which has a cross-sectional shape corresponding to inner section 58. The press is operated by a suitable actuator (not shown) that engages rubber strip 81, which prevents the press from jamming by cushioning platen 51 from the actuator.

During operation, a strip of panels, represented by dashed line 60, is inserted into the press and rests on inner section 58. Press 50 is closed, lowering platen 51. As the platen is lowered, pressure pad 75 comes to rest on strip 60. Because strip 60 is squeezed slightly between pressure pad 75 and inner section 58, the squeezed portion of the strip remains flat and dimensionally stable during subsequent cutting.

As platen 51 continues to descend, pressure pad 75 slides upwardly within stripper die 73 while pressure pad 75 maintains pressure on strip 60 as determined by the compression rate of spring 82, which is resiliently coupled to pressure pad 75 by movable pin 83. As pressure pad 75 moves upwardly, lower edge 84 of stripper die 73 moves past corner 85 on the upper surface of inner section 58. The shear force provides a kiss cut in the lamp layers on strip 60. The strip is-not completely cut because height 57 is not sufficient to cause a complete cut. Thus, stripper die 73 is used as a cutting die.

At this point the kiss cut is complete, the press can be opened, and strip 60 can be indexed to the next position or removed.

In a preferred embodiment of the invention, the kiss cut is combined with a blanking cut to produce individual panels on substrates. For a blanking cut, platen 51 is lowered further. Pressure pad 75 and stripper die 73 move together upwardly until outer corner 87 of outer section 56 moves past inner corner 88 of die 71. The motion is somewhat greater than the thickness of strip 60, sufficient to produce a through cut, thereby blanking out an EL panel. Guide 59 engages die 71 and is moved downward. The lower limit on the downward movement of guide 59 is shoulder 89 on outer section 56. As previously noted, guide rods, return springs, and the like, for guide 59 have been omitted for clarity.

After a panel is blanked from strip 60, press 50 is opened by raising platen 51. As platen 51 is raised, spring 81 lowers stripper die 73 and pressure pad 75, ejecting the blanked panel. Shoulder 74 in die 71 limits the downward travel of stripper die 73. Bolt 91 limits the downward travel of pressure pad 75 Strip 60 is moved to the next index position and the process is repeated. An EL panel is easily removed from the release layer, by a vacuum pickup for example.

The invention thus provides a long-life die for kiss cutting a laminated sheet. A punch and dies constructed as illustrated in FIG. 5 and made from tool steel are expected to last for at least 6,000,000 cycles, which greatly reduces the cost of the tooling. The pressure pad can be tool steel or common steel, case hardened if desired. The invention also provides a die for kiss cutting and blanking an article from a laminated sheet in a single operation and, in particular, for kiss cutting and blanking flexible EL lamps. The punch and dies are easily maintained with conventional die making tools, such as grinders and polishers. Thus, the tooling can be maintained in-house, which further reduces cost. The apparatus can be used on single panel sheets, strips having a plurality of EL panels, or on rolls of EL panels.

Having thus described the invention, it will be apparent to those of skill in the art that various modifications can be made within the scope of the invention. For example, inner section 58 need not have a completely flat upper surface but can be recessed or domed to suit a particular application. Similarly, while illustrated as square, corners 85 and 87 can be acute angles for improved cutting. A right angle is preferred and is much easier to machine and maintain. As previously noted, motion is relative. In the following claims, the recitation of one part as movable or another part as fixed is merely to provide a frame of reference for understanding the claim, not as a structural limitation.

What is claimed as the invention is:

1. A press for producing a kiss cut in laminated articles, said press comprising:
a punch;
a die; and
a stripper die within said die; said stripper die providing said kiss cut.

2. The press as set forth in claim 1 wherein said punch includes a raised upper surface creating a shoulder, wherein said shoulder engages said stripper die and produces said kiss cut.

3. The press as set forth in claim 2 wherein the laminated article is an EL panel and the height of said shoulder is slightly greater than the thickness of said EL panel.

4. The press as set forth in claim 2 wherein said punch can enter said die to produce a blanking cut.

5. The press as set forth in claim 1 wherein said punch includes an inner section and an outer section, wherein the inner section is higher than said outer section to engage said stripper die and produce said kiss cut.

6. The press as set forth in claim 5 wherein the laminated article is an EL panel and the height of said inner section above said outer section is slightly greater than the thickness of said EL panel.

7. The press as set forth in claim 5 wherein said punch can enter said die to produce a blanking cut.

8. A punch and die set for producing a kiss cut in laminated articles, said set comprising:
a cutting die having a cylindrical aperture and a first shoulder within said aperture;
a stripper die within said aperture, said stripper die having a second shoulder engaging said first shoulder when the stripper die is not in use;
a punch including an outer section and an inner section movable within said outer section, said punch characterized by said inner section extending above said outer section by a predetermined distance, whereby, when said punch engages said stripper die, a kiss cut is made in a workpiece.

9. The punch and die set as set forth in claim 8, and further including:
a pressure pad movable within said stripper die, said pressure pad being positioned to engage said workpiece prior to said kiss cut.

10. A method for kiss cutting laminated articles, said method comprising the steps of:
placing a laminated article between a punch and cutting die, wherein the cutting die contains a stripper die;
kiss cutting the article with the stripper die.

11. The method as set forth in claim 10 and further including the step of:
blanking a piece from said article by cutting the article with the cutting die after kiss cutting the article.
